(19) United States
(12) Patent Application Publication
(10) Pub. No.: US 2016/0295337 A1
(43) Pub. Date: Oct. 6, 2016

(54) METHOD OF MANUFACTURING A LOUDSPEAKER

(71) Applicant: Bose Corporation, Framingham, MA (US)

(72) Inventors: Joseph Jankovsky, Holliston, MA (US); Joseph A. Coffey, JR., Hudson, MA (US); Brendan J. Finnegan, Jamaica Plain, MA (US)

(73) Assignee: Bose Corporation, Framingham, MA (US)

(21) Appl. No.: 14/674,178

(22) Filed: Mar. 31, 2015

(51) Int. Cl. H04R 31/00; H04R 1/28; B32B 37/06; H04R 1/02; B32B 37/12; B32B 37/14

(52) U.S. Cl. CPC H04R 31/00; B32B 37/12; B32B 37/14; B32B 37/06; H04R 1/023; H04R 1/288; B32B 2307/10

(57) ABSTRACT

A method for manufacturing a loudspeaker includes creating a dual-layered fabric having an acoustic resistance by attaching a first fabric having a first acoustic resistance to a second fabric having a second acoustic resistance lower than the first acoustic resistance. The method further includes applying a coating material to a first portion of the dual-layered fabric. The coating material forms a pattern on the first portion of the dual-layered fabric that changes the acoustic resistance of the dual-layered fabric along at least one of: a length and radius of the dual-layered fabric.

### BACKGROUND

This disclosure relates to a method for manufacturing a loudspeaker.

Loudspeakers generally include a diaphragm and a linear motor. When driven by an electrical input signal, the linear motor moves the diaphragm to cause vibrations in air, thereby generating sound. Various techniques have been used to control the directivity and radiation pattern of a loudspeaker, including acoustic horns, pipes, slots, waveguides, and other structures that redirect or guide the generated sound waves. In some of these structures, an opening in the horn, pipe, slot or waveguide is covered with an acoustically resistive material to improve the performance of the loudspeaker over a wider range of frequencies.

### SUMMARY

In general, in some aspects a method for manufacturing a loudspeaker includes creating a dual-layered fabric having an acoustic resistance by attaching a first fabric having a first acoustic resistance to a second fabric having a second acoustic resistance lower than the first acoustic resistance. The method further includes applying a coating material to a first portion of the dual-layered fabric. The coating material forms a pattern on the first portion of the dual-layered fabric that changes the acoustic resistance of the dual-layered fabric along at least one of: a length and radius of the dual-layered fabric.

Implementations may include any, all or none of the following features. The first acoustic resistance may be approximately 1,000 Rayls. The first fabric may be a monofilament fabric. The second fabric may be a monofilament fabric. The first fabric may be attached to the second fabric using at least one of: a solvent and an adhesive.

Applying a coating material to a first portion of the dual-layered fabric may include masking a second portion of the dual-layered fabric, the second portion being adjacent to the first portion. Applying a coating material to a first portion of the dual-layered fabric may further include applying the coating material to an unmasked portion of the dual-layered fabric. Applying a coating material to a first portion of the dual-layered fabric may include selectively depositing the coating material to form the pattern on the first portion of the dual-layered fabric. Applying a coating material to a first portion of the dual-layered fabric may include attaching a pre-cut sheet of material to the first portion of the dual-layered fabric. The coating material may include at least one of: paint, an adhesive, and a polymer.

The method may further include thermoforming the dual-layered fabric into at least one of: a spherical shape, a semi-spherical shape, a conical shape, a toroidal shape, and a shape comprising a section of a sphere, cone or toroid.

The method may further include attaching the dual-layered fabric to an acoustic waveguide.

The method may further include attaching an electro-acoustic driver to the acoustic waveguide.

In general, in some aspects a method of manufacturing a loudspeaker includes providing a fabric having an acoustic resistance and applying a coating material to a first portion of the fabric. The coating material forms a pattern on the first portion of the fabric that changes the acoustic resistance of the fabric along at least one of: a length and radius of the fabric.

Implementations may include any, all or none of the following features. The acoustic resistance may be approximately 1,000 Rayls. The fabric may include a monofilament fabric.

Applying a coating material to a first portion of the fabric may include masking a second portion of the fabric, the second portion being adjacent to the first portion. Applying a coating material to a first portion of the fabric may further include applying the coating material to an unmasked portion of the fabric. Applying a coating material to a first portion of the fabric may include selectively depositing the coating material to form the pattern on the first portion of the fabric. Applying a coating material to a first portion of the fabric may include attaching a pre-cut sheet of material to the first portion of the fabric. The coating material may include at least one of: paint, an adhesive, and a polymer.

The method may further include thermoforming the fabric into at least one of: a spherical shape, a semi-spherical shape, a conical shape, a toroidal shape, and a shape comprising a section of a sphere, cone or toroid.

The method may further include attaching the fabric to an acoustic waveguide.

The method may further include attaching an electro-acoustic driver to the acoustic waveguide.

In general, in some aspects a method of manufacturing a loudspeaker includes creating a dual-layered fabric having an acoustic resistance by attaching a first fabric having a first acoustic resistance to a second fabric having a second acoustic resistance lower than the first resistance. The method further includes altering the acoustic resistance of the dual-layered fabric along at least one of: a length and radius of the dual-layered fabric by fusing a first portion of the dual-layered fabric to form a substantially opaque pattern on the first portion of the dual-layered fabric.

Implementations may include any, all or none of the following features. The first acoustic resistance may be approximately 1,000 Rayls. The first fabric and the second fabric may each include a monofilament fabric. The first fabric may be attached to the second fabric using at least one of: a solvent and an adhesive. Fusing a first portion of the dual-layered fabric may include heating the dual-layered fabric.

The method may further include thermoforming the dual-layered fabric into at least one of: a spherical shape, a semi-spherical shape, a conical shape, a toroidal shape, and a shape comprising a section of a sphere, cone or toroid.

The method may further include attaching the dual-layered fabric to an acoustic waveguide.

The method may further include attaching an electro-acoustic driver to the acoustic waveguide.

Implementations may include one of the above and/or below features, or any combination thereof. Other features and advantages will be apparent from the description and the claims.

### BRIEF DESCRIPTION OF THE DRAWINGS

For purposes of illustration some elements are omitted and some dimensions are exaggerated. For ease of reference, like reference numbers indicate like features throughout the referenced drawings.

FIG. 1A is perspective view of a loudspeaker.

FIG. 1B is front view of the loudspeaker of FIG. 1A.

FIG. 1C is a back view of the loudspeaker of FIG. 1A.

FIG. 2 shows a flow chart of a method for manufacturing the loudspeaker of FIGS. 1A through 1C.

FIG. 3 shows a flow chart of an alternative method for manufacturing the loudspeaker of FIGS. 1A through 1C.

FIG. 4 shows a flow chart of an alternative method for manufacturing the loudspeaker of FIGS. 1A through 1C.

FIG. 5 shows a flow chart of an alternative method for manufacturing the loudspeaker of FIGS. 1A through 1C

FIG. 6 shows a flow chart of a step that may be used in the methods for manufacturing shown in FIGS. 2 and 3.

### DETAILED DESCRIPTION

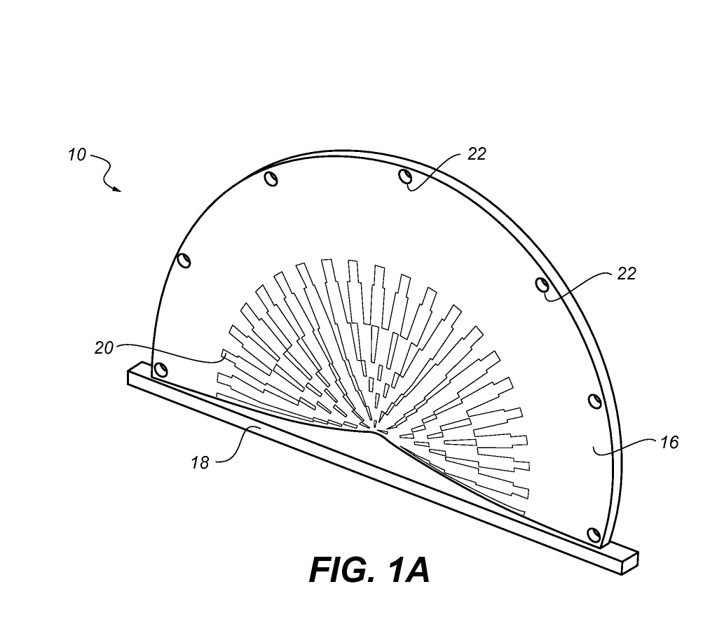

A loudspeaker 10, shown in FIGS. 1A through 1C, includes an electro-acoustic driver 12 coupled to an acoustic waveguide 14. The acoustic waveguide 14 is coupled to a resistive screen 16, on which an acoustically resistive pattern 20 is applied. The acoustically resistive pattern 20 may be a substantially opaque and impervious layer that is applied to or generated on the resistive screen 16. The electro-acoustic driver 12, acoustic waveguide 14, and resistive screen 16 together may be mounted onto a base section 18. The base section 18 may be formed integrally with the acoustic waveguide 14 or may be formed separately. The loudspeaker 10 may also include a plurality of mounting holes 22 for mounting the loudspeaker 10 in, for example, a ceiling, wall, or other structure. One such loudspeaker 10 is described in U.S. patent application ______, titled “Directional Acoustic Device” filed on Mar. 31, 2015, the entire contents of which are incorporated herein by reference.

The electro-acoustic driver 12 typically includes a motor structure mechanically coupled to a radiating component, such as a diaphragm, cone, dome, or other surface. Attached to the inner edge of the cone may be a dust cover or dust cap, which also may be dome-shaped. In operation, the motor structure operates as a linear motor, causing the radiating surface to vibrate along an axis of motion. This movement causes changes in air pressure, which results in the production of sound. The electro-acoustic driver 12 may be a mid-high or high frequency driver, typically having an operating range of 200 Hz to 16 kHz. The electro-acoustic driver 12 may be of numerous types, including but not limited to a compression driver, cone driver, mid-range driver, full-range driver, and tweeter. Although one electro-acoustic driver is shown in FIGS. 1A through 1C, any number of drivers could be used. In addition, the one or more electro-acoustic drivers 12 could be coupled to the acoustic waveguide 14 via an acoustic passage or manifold component, such as those described in U.S. Patent Publication No. 2011-0064247, the entire contents of which are incorporated herein by reference.

The electro-acoustic driver 12 is coupled to an acoustic waveguide 14 which, in the example of FIGS. 1A through 1C, guides the generated sound waves in a radial direction away from the electro-acoustic driver 12. The loudspeaker 10 could be any number of shapes, including but not limited to circular, semi-circular, spherical, semi-spherical, conical, semi-conical, toroidal, semi-toroidal, rectangular, and a shape comprising a section of a circle, sphere, cone, or toroid. In examples where the loudspeaker 10 has a non-circular or non-spherical shape, the acoustic waveguide 14 guides the generated sound waves in a direction away from the electro-acoustic driver 12. The acoustic waveguide 14 may be constructed of a metal or plastic material, including but not limited to thermoset polymers and thermoplastic polymer resins such as polyethylene terephthalate (PET), polypropylene (PP), and polyethylene (PE). Moreover, fibers of various materials, including fiberglass, may be added to the polymer material for increased strength and durability. The acoustic waveguide 14 could have a substantially solid structure, as shown in FIGS. 1A through 1C, or could have hollow portions, for example a honeycomb structure.

Before the generated sound waves reach the external environment, they pass through a resistive screen 16 coupled to an opening in the acoustic waveguide 14. The resistive screen 16 may include one or more layers of a mesh material or fabric. In some examples, the one or more layers of material or fabric may each be made of monofilament fabric (i.e., a fabric made of a fiber that has only one filament, so that the filament and fiber coincide). The fabric may be made of polyester, though other materials could be used, including but not limited to metal, cotton, nylon, acrylic, rayon, polymers, aramids, fiber composites, and/or natural and synthetic materials having the same, similar, or related properties, or a combination thereof. In other examples, a multifilament fabric may be used for one or more of the layers of fabric.

In one example, the resistive screen 16 is made of two layers of fabric, one layer being made of a fabric having a relatively high acoustic resistance compared to the second layer. For example, the first fabric may have an acoustic resistance ranging from 200 to 2,000 Rayls, while the second fabric may have an acoustic resistance ranging from 1 to 90 Rayls. The second layer may be a fabric made of a coarse mesh to provide structural integrity to the resistive screen 16, and to prevent movement of the screen at high sound pressure levels. In one example, the first fabric is a polyester-based fabric having an acoustic resistance of approximately 1,000 Rayls (e.g., Saatifil® Polyester PES 10/3 supplied by Saati of Milan, Italy) and the second fabric is a polyester-based fabric made of a coarse mesh (e.g., Saatifil® Polyester PES 42/10 also supplied by Saati of Milan, Italy). In other examples, however, other materials may be used. In addition, the resistive screen 16 may be made of a single layer of fabric or material, such as a metal-based mesh or a polyester-based fabric. And in still other examples, the resistive screen 16 may be made of more than two layers of material or fabric. The resistive screen 16 may also include a hydrophobic coating to make the screen water-resistant.

The resistive screen 16 also includes an acoustically resistive pattern 20 that is applied to or generated on the surface of the resistive screen 16. The acoustically resistive pattern 20 may be a substantially opaque and impervious layer. Thus, in the places where the acoustically resistive pattern 20 is applied, it substantially blocks the holes in the mesh material or fabric, thereby creating an acoustic resistance that varies as the generated sound waves move radially outward through the resistive screen 16 (or outward in a linear direction for non-circular and non-spherical shapes). For example, where the acoustic resistance of the resistive screen 16 without the acoustically resistive pattern 20 is approximately 1,000 Rayls over a prescribed area, the acoustic resistance of the resistive screen 16 with the acoustically resistive pattern 20 may be approximately 10,000 Rayls over an area closer to the electro-acoustic driver 12, and approximately 1,000 Rayls over an area closer to the edge of the loudspeaker 10 (e.g., in areas that do not include the acoustically resistive pattern 20). The size, shape, and thickness of the acoustically resistive pattern 20 may vary, and just one example is shown in FIGS. 1A through 1C.

The material used to generate the acoustically resistive pattern 20 may vary depending on the material or fabric used for the resistive screen 16. In the example where the resistive screen 16 comprises a polyester fabric, the material used to generate the acoustically resistive pattern 20 may be paint (e.g., vinyl paint), or some other coating material that is compatible with polyester fabric. In other examples, the material used to generate the acoustically resistive pattern 20 may be an adhesive or a polymer. In still other examples, rather than add a coating material to the resistive screen 16, the acoustically resistive pattern 20 may be generated by transforming the material comprising the resistive screen 16, for example by heating the resistive screen 16 to selectively fuse the intersections of the mesh material or fabric, thereby substantially blocking the holes in the material or fabric.

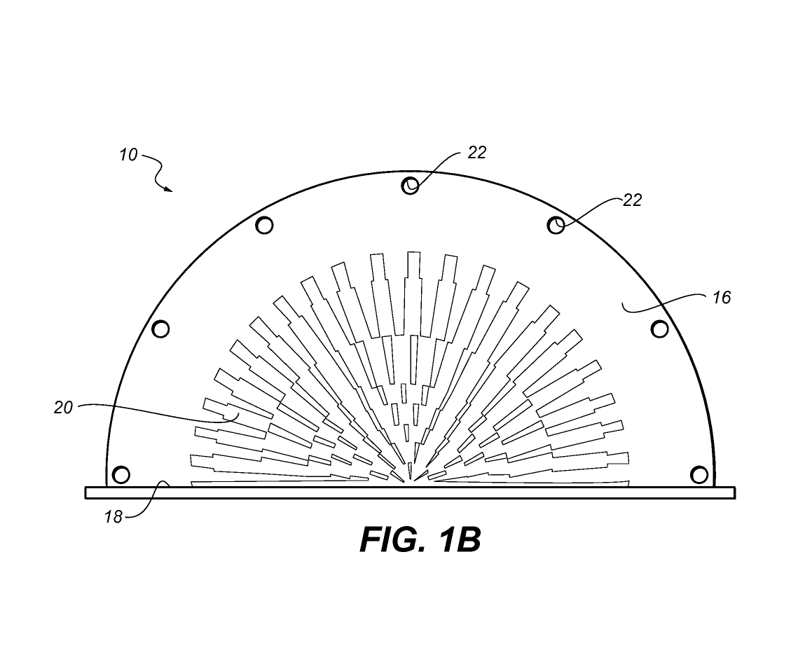

FIG. 2 shows a flow chart of a method 100 for manufacturing the loudspeaker 10 of FIGS. 1A through 1C in the example where the resistive screen 16 is made of two layers of fabric, and a coating material is applied to the resistive screen 16 to form the acoustically resistive pattern 20. Although steps 102-112 of FIG. 2 are shown as occurring in a certain order, it should be readily understood that the steps 102-112 could occur in a different order than is shown. Moreover, although steps 102-112 of FIG. 2 are shown as occurring separately, it should be readily understood that certain of the steps could be combined and occur at the same time. As shown in FIG. 2, to begin formation of the resistive screen 16, a first fabric is attached to a second fabric in step 102. The two fabrics may be attached by, for example, using a layer of solvent, adhesive, or glue that joins the two layers of fabric. Alternatively, the fabrics may be heated to a temperature that permits the two fabrics to be joined to each other. For example, the fabrics may be placed in mold that heats the fabrics to a predetermined temperature for a predetermined length of time until the fabrics adhere to each other, or a laser (or other heat-applying apparatus) may be used to selectively apply heat to portions of the fabrics until those portions adhere to each other. Alternatively, the fabrics could be joined by thermoforming, pressure forming and/or vacuum forming the fabrics.

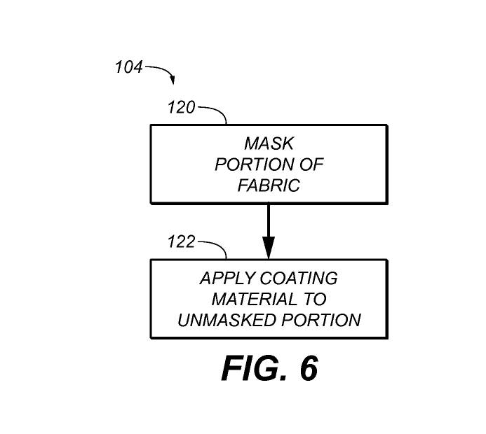

In step 104, a coating material (such as paint, an adhesive or a polymer) is applied to the resistive screen 16 to form the acoustically resistive pattern 20. In one example, as shown in FIG. 6, the coating material could be applied using a mask. In that example, a portion of the fabric could be masked (in step 120), and the coating material could be applied to the unmasked portion of the fabric (in step 122), by, for example, spraying or otherwise depositing the coating material onto the unmasked portion of the fabric. In some examples, after the mask has been applied, a coating material (e.g., adhesive beads or polymer beads) could be deposited on the unmasked portion of the fabric, and then melted onto the fabric via the application of heat. The coating material could be applied to the resistive screen 16 using other methods besides a mask, however. For example, the coating material could be pre-cut (for example, using a laser cutter or die cutter), and could then be ironed-on to the fabric or attached using an adhesive. For example, the coating material could comprise a sheet of polymer plastic, metal, paper, or any substantially opaque material having the same, similar, or related properties (or any combination thereof) that is pre-cut into the desired acoustically resistive pattern 20. The sheet could then be attached to the fabric via the application of heat or an adhesive. In yet another example, the coating material could be deposited directly onto the fabric, using a machine that can draw out the desired pattern 20, thereby selectively applying the coating material only to the portion of the fabric that should have the acoustically resistive pattern 20. In addition, the coating material could be applied to the resistive screen 16 using other known methods, including but not limited to a silkscreen, spray paint, ink jet printing, etching, melting, electrostatic coating, or any combination thereof.

Optionally, in step 106, the coating material may be cured, by, for example, baking the assembly at a predetermined temperature, applying ultraviolet (UV) light to the coating material, exposing the coating material to the air, or any combination thereof. If a coating material is selected that does not need to be cured, step 106 would be omitted. In some examples, steps 102, 104 and 106 could be combined into a single step. For example, the first and second layers of fabric could be placed on top of each other, and a UV-curable adhesive could be deposited onto one layer of the fabric in the desired acoustically resistive pattern 20. The adhesive could then be cured via the application of UV light, which would also result in adhering the two layers of fabric.

In step 108, the fabric is formed into the desired shape for the loudspeaker 10. For example, the fabric may be formed to be a semi-circle, circle, sphere, semi-sphere, rectangle, cone, toroid, or a shape comprising a section of a circle, sphere, cone, toroid and/or rectangle. The loudspeaker 10 may also be bent and/or curved along its length, as described, for example, in U.S. Pat. No. 8,351,630, the entire contents of which are incorporated herein by reference. These various shapes may be created by thermoforming the fabric (i.e., heating it to a pliable forming temperature and then forming it to a specific shape in a mold) and/or vacuum or pressure forming the fabric. Although FIG. 2 shows step 108 as occurring after the coating material has been applied to the resistive screen 16, in other examples, the fabric could be formed into the desired shape before the coating material is applied. Moreover, step 108 could be combined with step 102, so that the forming process also joins the two layers of fabric.

In step 110, the resistive screen 16 is attached to the acoustic waveguide 14 via an adhesive, double-sided tape, a fastener (e.g., a screw, bolt, clamp, clasp, clip, pin or rivet), or other known methods. And in step 112, the electro-acoustic driver 12 is attached to the acoustic waveguide 14. The electro-acoustic driver 12 could be secured to the acoustic waveguide 14 via a fastener or other known methods. Although FIG. 2 shows step 112 as occurring after the fabric has been attached to the acoustic waveguide, in other examples, the electro-acoustic transducer could be attached to the waveguide before the fabric is attached. The acoustic waveguide 14 could be constructed via compression molding, injection molding, plastic machining, or other known methods.

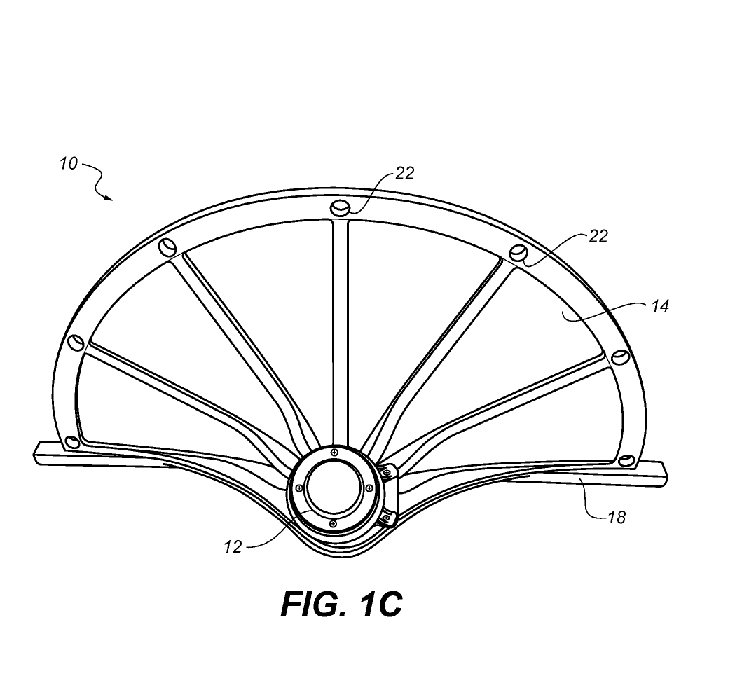

FIG. 3 shows a flow chart of an alternative method 200 for manufacturing the loudspeaker 10 of FIGS. 1A through 1C in the example where the resistive screen 16 is made of a single layer of fabric, and a coating material is applied to the resistive screen 16 to form the acoustically resistive pattern 20. Although steps 201-212 of FIG. 3 are shown as occurring in a certain order, it should be readily understood that the steps 201-212 could occur in a different order than is shown. Moreover, although steps 201-212 of FIG. 2 are shown as occurring separately, it should be readily understood that certain of the steps could be combined and occur at the same time. As shown in FIG. 3, to begin formation of the resistive screen 16, a fabric is provided in step 201. In step 204, a coating material (such as paint, an adhesive or a polymer) is applied to the fabric to form the acoustically resistive pattern 20. The coating material could be applied using the methods previously described in connection with FIG. 2 (e.g., via a mask, a pre-cut sheet of material, by depositing the coating material directly onto the fabric in the desired pattern 20, or via a silkscreen, spray paint, ink jet printing, etching, melting, electrostatic coating, or any combination thereof).

Optionally, in step 206, the coating material may be cured, by, for example, the methods previously described in connection with FIG. 2 (e.g., baking the assembly at a predetermined temperature, applying UV light to the coating material, exposing the coating material to the air, or any combination thereof). If a coating material is selected that does not need to be cured, step 206 would be omitted. As with the example shown in FIG. 2, steps 201, 204 and 206 could be combined into a single step.

In step 208, the fabric is formed into the desired shape for the loudspeaker 10. As with the example of FIG. 2, the fabric may be formed to be a semi-circle, circle, sphere, semi-sphere, rectangle, cone, toroid, or a shape comprising a section of a circle, sphere, cone, toroid and/or rectangle. The loudspeaker 10 may also be bent and/or curved along its length, as described, for example, in U.S. Pat. No. 8,351,630. These various shapes may be created by thermoforming the fabric (i.e., heating it to a pliable forming temperature and then forming it to a specific shape in a mold) and/or vacuum or pressure forming the fabric. Although FIG. 3 shows step 208 as occurring after the coating material has been applied to the resistive screen 16, in other examples, the fabric could be formed into the desired shape before the coating material is applied.

As with the example of FIG. 2, in step 210, the resistive screen 16 is attached to the acoustic waveguide 14 via an adhesive, double-sided tape, a fastener (e.g., a screw, bolt, clamp, clasp, clip, pin or rivet) or other known methods; and in step 212, the electro-acoustic driver 12 is attached to the acoustic waveguide 14 via a fastener or other known methods. Although FIG. 3 shows step 212 as occurring after the fabric has been attached to the acoustic waveguide, in other examples, the electro-acoustic transducer could be attached to the waveguide before the fabric is attached. As with the example of FIG. 2, the acoustic waveguide 14 could be constructed via compression molding, injection molding, plastic machining, or other known methods.

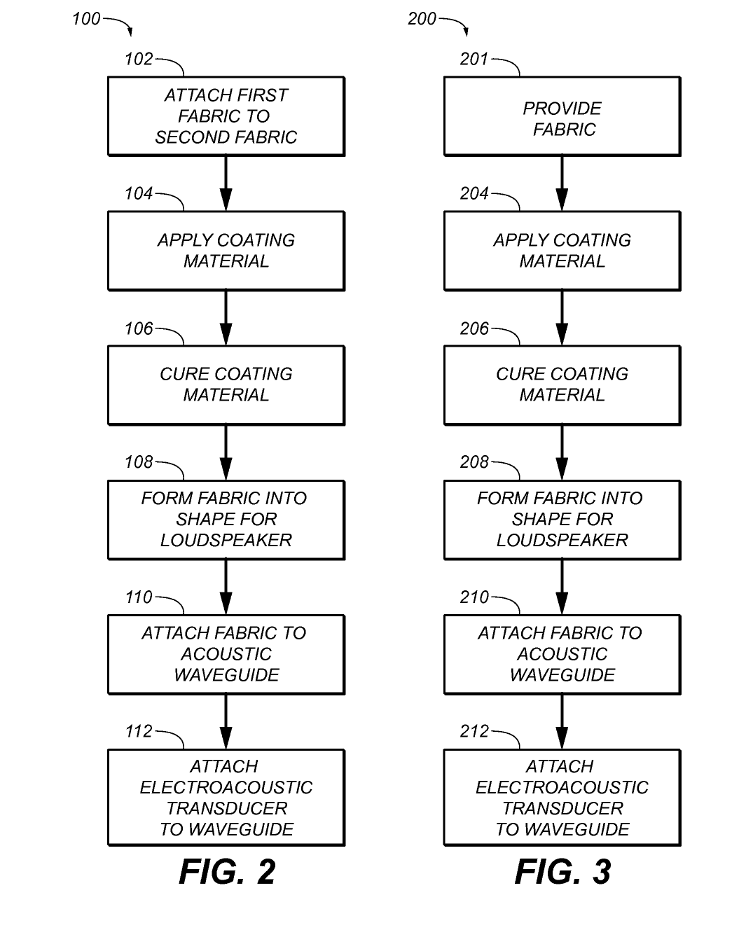

FIG. 4 shows a flow chart of an alternative method 300 for manufacturing the loudspeaker 10 of FIGS. 1A through 1C in the example where the resistive screen 16 is made of two layers of fabric, and the acoustically resistive pattern 20 is formed by fusing the intersections of the fabric, thereby substantially blocking the holes in the fabric. Although steps 302-312 of FIG. 4 are shown as occurring in a certain order, it should be readily understood that the steps 302-312 could occur in a different order than is shown. Moreover, although steps 302-312 of FIG. 4 are shown as occurring separately, it should be readily understood that certain of the steps could be combined and occur at the same time. As shown in FIG. 4, to begin formation of the resistive screen 16, a first fabric is attached to a second fabric in step 302. The first fabric could be attached to the second fabric using the methods previously described in connection with FIG. 2 (e.g., via a layer of solvent, adhesive or glue, or via heating, thermoforming, pressure forming, vacuum forming, or any combination thereof).

In step 303, the fabric is fused to form the acoustically resistive pattern 20, such that the holes in the fabric are substantially blocked, thereby creating a substantially opaque and impervious layer on the fabric. The fabric could be fused by, for example, applying heat to the portions of the fabric that should have the acoustically resistive pattern 20, or by selectively applying chemical bonding elements to the portions of the fabric that should have the acoustically resistive pattern 20.

As with the examples of FIGS. 2 and 3, in step 308, the fabric is formed into the desired shape for the loudspeaker 10 (e.g., via thermoforming, vacuum forming and/or pressure forming); in step 310, the resistive screen 16 is attached to the acoustic waveguide 14; and in step 312, the electro-acoustic driver 12 is attached to the acoustic waveguide 14. These steps could be completed using the methods previously described in connection with FIGS. 2 and 3.

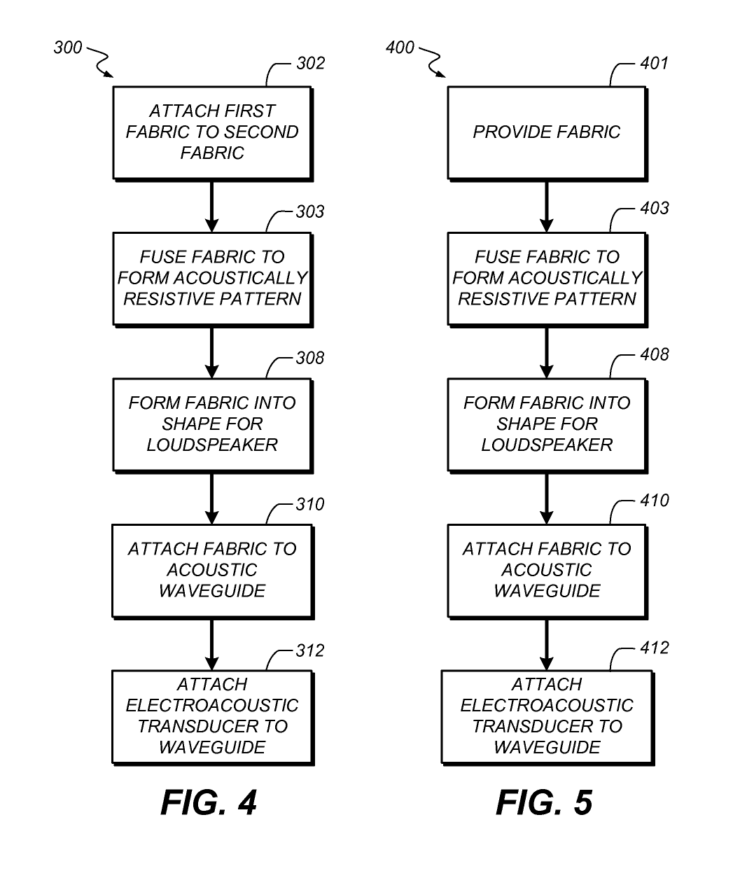

FIG. 5 shows a flow chart of an alternative method 400 for manufacturing the loudspeaker 10 of FIGS. 1A through 1C in the example where the resistive screen 16 is made of a single layer of fabric, and the acoustically resistive pattern 20 is formed by fusing the intersections of the fabric, thereby substantially blocking the holes in the fabric. Although steps 401-412 of FIG. 5 are shown as occurring in a certain order, it should be readily understood that the steps 401-412 could occur in a different order than is shown. Moreover, although steps 401-412 of FIG. 5 are shown as occurring separately, it should be readily understood that certain of the steps could be combined and occur at the same time. As shown in FIG. 5, to begin formation of the resistive screen 16, a fabric is provided in step 401.

In step 403, the fabric is fused to form the acoustically resistive pattern 20, such that the holes in the fabric are substantially blocked, thereby creating a substantially opaque and impervious layer on the fabric. The fabric could be fused by, for example, applying heat to the portions of the fabric that should have the acoustically resistive pattern 20, or by selectively applying chemical bonding elements to the portions of the fabric that should have the acoustically resistive pattern 20.

As with the examples of FIGS. 2 through 4, in step 408, the fabric is formed into the desired shape for the loudspeaker 10 (e.g., via thermoforming, vacuum forming and/or pressure forming); in step 410, the resistive screen 16 is attached to the acoustic waveguide 14; and in step 412, the electro-acoustic driver 12 is attached to the acoustic waveguide 14. These steps could be completed using the methods previously described in connection with FIGS. 2 through 4.

A number of implementations have been described. Nevertheless, it will be understood that additional modifications may be made without departing from the scope of the inventive concepts described herein, and, accordingly, other embodiments are within the scope of the following claims.

What is claimed is:

1. A method of manufacturing a loudspeaker comprising:
creating a dual-layered fabric having an acoustic resistance by attaching a first fabric having a first acoustic resistance to a second fabric having a second acoustic resistance lower than the first acoustic resistance;
applying a coating material to a first portion of the dual-layered fabric, wherein the coating material forms a pattern on the first portion of the dual-layered fabric that changes the acoustic resistance of the dual-layered fabric along at least one of: a length and radius of the dual-layered fabric.

2. The method of claim 1, wherein the first acoustic resistance is approximately 1,000 Rayls.

3. The method of claim 1, wherein the first fabric comprises a monofilament fabric.

4. The method of claim 1, wherein the second fabric comprises a monofilament fabric.

5. The method of claim 1, wherein the first fabric is attached to the second fabric using at least one of: a solvent and an adhesive.

6. The method of claim 1, wherein applying a coating material to a first portion of the dual-layered fabric comprises masking a second portion of the dual-layered fabric, the second portion being adjacent to the first portion.

7. The method of claim 6, wherein applying a coating material to a first portion of the dual-layered fabric further comprises applying the coating material to an unmasked portion of the dual-layered fabric.

8. The method of claim 1, wherein applying a coating material to a first portion of the dual-layered fabric comprises selectively depositing the coating material to form the pattern on the first portion of the dual-layered fabric.

9. The method of claim 1, wherein applying a coating material to a first portion of the dual-layered fabric comprises attaching a pre-cut sheet of material to the first portion of the dual-layered fabric.

10. The method of claim 1, wherein the coating material comprises at least one of: paint, an adhesive, and a polymer.

11. The method of claim 1, further comprising thermoforming the dual-layered fabric into at least one of: a spherical shape, a semi-spherical shape, a conical shape, a toroidal shape, and a shape comprising a section of a sphere, cone or toroid.

12. The method of claim 11, further comprising attaching the dual-layered fabric to an acoustic waveguide.

13. The method of claim 12, further comprising attaching an electro-acoustic driver to the acoustic waveguide.

14. A method of manufacturing a loudspeaker comprising:
providing a fabric having an acoustic resistance;
applying a coating material to a first portion of the fabric,
wherein the coating material forms a pattern on the first portion of the fabric that changes the acoustic resistance of the fabric along at least one of: a length and radius of the fabric.

15. The method of claim 14, wherein the acoustic resistance is approximately 1,000 Rayls.

16. The method of claim 14, wherein the fabric comprises a monofilament fabric.

17. The method claim 14, wherein applying a coating material to a first portion of the fabric comprises masking a second portion of the fabric, the second portion being adjacent to the first portion.

18. The method of claim 17, wherein applying a coating material to a first portion of the fabric further comprises applying the coating material to an unmasked portion of the fabric.

19. The method of claim 14, wherein applying a coating material to a first portion of the fabric comprises selectively depositing the coating material to form the pattern on the first portion of the fabric.

20. The method of claim 14, wherein applying a coating material to a first portion of the fabric comprises attaching a pre-cut sheet of material to the first portion of the fabric.

21. The method of claim 14, wherein the coating material comprises at least one of: paint, an adhesive, and a polymer.

22. The method of claim 14, further comprising thermoforming the fabric into at least one of: a spherical shape, a semi-spherical shape, a conical shape, a toroidal shape, and a shape comprising a section of a sphere, cone or toroid.

23. The method of claim 22, further comprising attaching the fabric to an acoustic waveguide.

24. The method of claim 23, further comprising attaching an electro-acoustic driver to the acoustic waveguide.

25. A method of manufacturing a loudspeaker comprising:
creating a dual-layered fabric having an acoustic resistance by attaching a first fabric having a first acoustic resistance to a second fabric having a second acoustic resistance lower than the first resistance;
altering the acoustic resistance of the dual-layered fabric along at least one of: a length and radius of the dual-layered fabric, comprising:
fusing a first portion of the dual-layered fabric to form a substantially opaque pattern on the first portion of the dual-layered fabric.

26. The method of claim 25, wherein the first acoustic resistance is approximately 1,000 Rayls.

27. The method of claim 25, wherein the first fabric and the second fabric each comprise a monofilament fabric.

28. The method of claim 25, wherein the first fabric is attached to the second fabric using at least one of: a solvent and an adhesive.

29. The method of claim 25, wherein fusing a first portion of the dual-layered fabric comprises heating the dual-layered fabric.

30. The method of claim 25, further comprising thermoforming the dual-layered fabric into at least one of: a spherical shape, a semi-spherical shape, a conical shape, a toroidal shape, and a shape comprising a section of a sphere, cone or toroid.

31. The method of claim 30, further comprising attaching the dual-layered fabric to an acoustic waveguide.

32. The method of claim 31, further comprising attaching an electro-acoustic driver to the acoustic waveguide.
